(19) United States
(12) Patent Application Publication
(10) Pub. No.: US 2008/0078090 A1
(43) Pub. Date: Apr. 3, 2008

(54) Manual Saw Guard Retracting Device

(76) Inventor: Charles E. Johnson III, Fullerton, CA (US)

Correspondence Address: LAW OFFICES OF JOSEPH R. CRUSE, JR., 28215 AGOURA ROAD, SUITE 130, AGOURA HILLS, CA, 91301, US

(21) Appl. No.: 11/750,668

(22) Filed: May 18, 2007

Related U.S. Application Data
(60) Provisional application No. 60/801,685, filed on May 19, 2006.

(51) Int. Cl. B27G 19/04

(52) U.S. Cl. 30/391

(57) ABSTRACT

A Manual Saw Guard Retracting Apparatus which comprises a manual driver and a fixed rigid connector attached to a movable lower safety guard on a conventional power saw that can move the lower movable safety guard out of the operator's way and return the lower movable saw guard to a safe position as soon as the operator either releases pressure from the driver end button or otherwise disengages from the saw.

### FIELD OF THE INVENTION

This invention relates to saw safety guard devices, and more specifically pertains to a new manual safety guard apparatus for manually moving a safety guard on a conventional power saw enabling the operator to move the safety guard without placing his hand and fingers near the saw blade.

### BACKGROUND OF THE INVENTION

Conventional power saws commonly are equipped with a fixed upper safety guard and a movable lower safety guard for protecting the operator from the saw blade. For safety reasons, this lower safety guard is in an engaged position until the object being cut by the saw passes under the guard and moves it out of the way.

Prior to opening, the guard obstructs the operator's view of the path to be cut on the object. This obstruction requires the operator to look to the open side of the saw and view the line to be cuts placing the operator into a more dangerous position as his eyes and face are no longer protected by the fixed upper safety guard.

In order to remedy this situation the operator will move the lower safety guard manually out of the way by placing the hand that is not holding the main saw handle, directly on the lower guard and moving, out it of the way. This is extremely dangerous, in that the lower guard is located in extremely close proximity to the moving saw blade, placing the operator's fingers, thumb and hand in great peril. Also, by using the other hand to manually move the lower guard out of position, the operator looses control over the object that he is cutting, risking additional harm should the object shift or move.

Accordingly, besides the objects and advantages of the saw safety guards described above, several objects and advantages of the present invention are:

(a) to provide a power saw safety apparatus that will enable the operator's face and eyes to remain protected by the fixed upper safety saw guard by allowing the operator to move the lower safety guard out of the way to better view the cutting line that is obstructed by the lower safety guard when it is engaged;

(b) to provide a power saw safety apparatus that will enable the operator to manually lift the lower movable safety guard of the saw out of the way using the same hand that is holding the power saw, enabling the operator to continue to hold the saw firmly and securely while cutting.

(c) to provide a power saw safety apparatus that will enable the operator to manually lift the lower movable safety guard of the saw out of the way, while continuing to keep his hands, finger and/or thumb protected above the saw's fixed upper safety guard;

(d) to provide a power saw safety apparatus that will re-engage the lower safety guard immediately when the operator removes his thumb from the button; and

(e) to provide a power saw safety apparatus that will re-engage the lower safety guard immediately when the operator removes himself from the power saw, ensuring that the saw blade will be safely covered when the operator sets the saw down, further ensuring that the operator will be in compliance with safety regulations as they relate to power saws and safety guards oil most construction sites; and

(f) to provide a power saw safety apparatus that is light, inexpensive, uncomplicated and easy to operate for both right and left-handed operators.

Further objects and advantages are to provide a closure and re-engagement of the lower safety guard apparatus which can be used for ensured safety and additional compliance with safety regulations. Still further objects and advantages will become apparent from a consideration of the ensuing description and drawing.

### DESCRIPTION

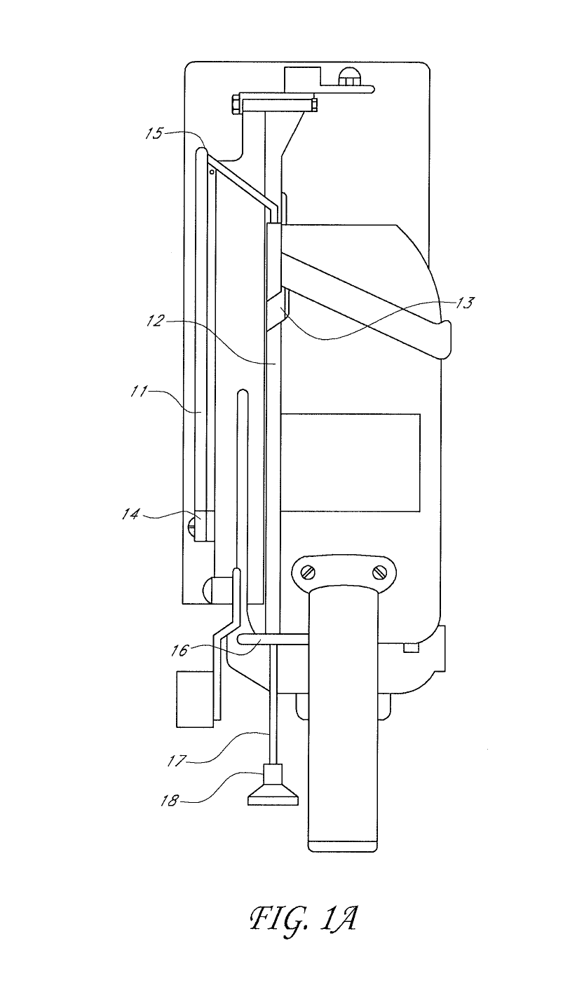

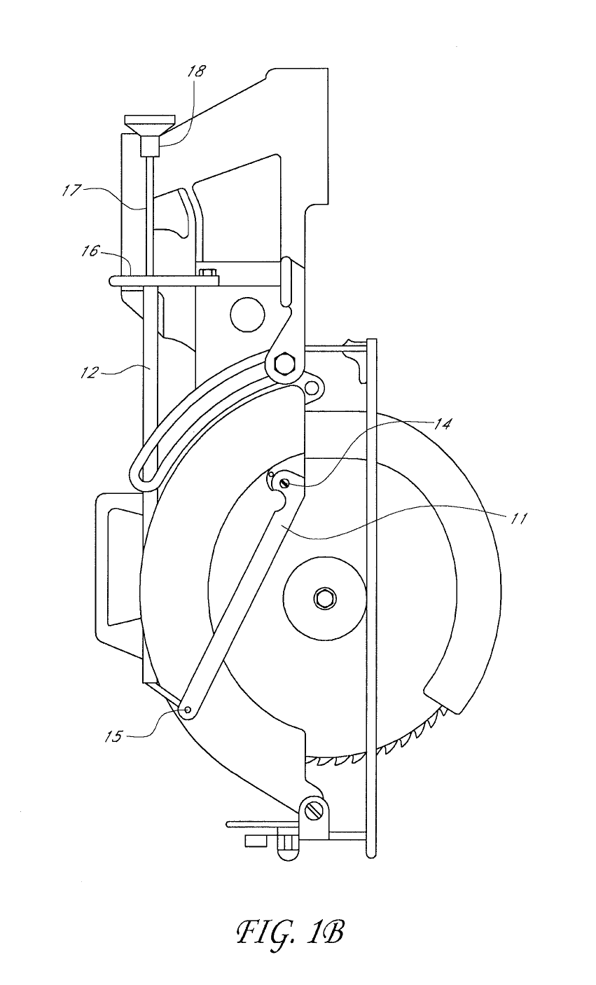

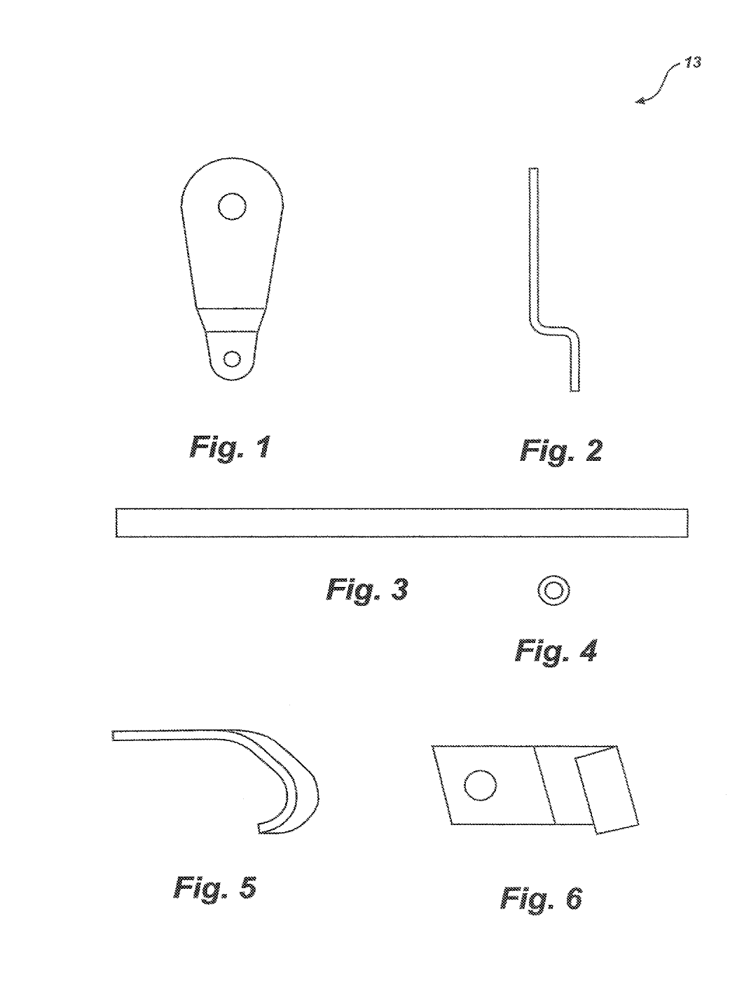

FIG. 1A shows a top view of a conventional power saw equipped with a manual safety guard apparatus for manually moving a lower movable safety guard.

FIG. 1B shows a side view of a conventional power saw equipped with a manual safety guard apparatus for manually moving a lower movable safety guard.

FIG. 1 shows a front view of the Top Mount Plate

FIG. 2 shows a side view of the Top Mount Plate

FIG. 3 shows a side view of the Driver Housing

FIG. 4 shows an end view of the Driver Housing

FIG. 5 shows a side view of the Driver Housing Clip

FIG. 6 shows a perspective view of the Driver Housing Clip

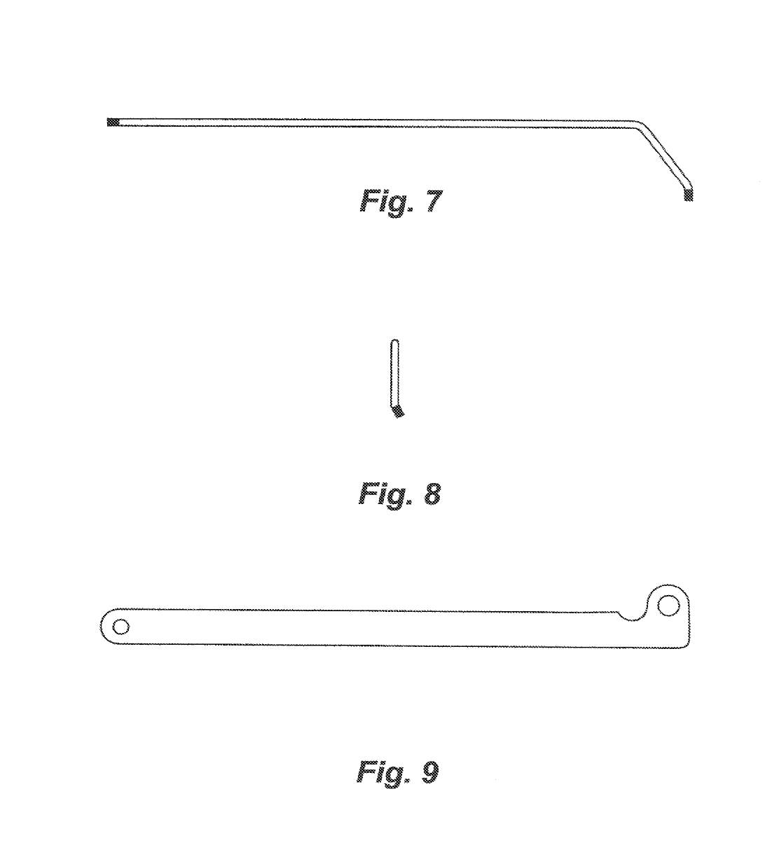

FIG. 7 shows a side view of the Driver

FIG. 8 Shows an end view of the Driver

FIG. 9 shows a front view of the Fixed Connecting Rod

### DRAWINGS—REFERENCE NUMERALS

11 Fixed Connecting Rod

12 Driver Housing,

13 Driver Housing Clip

14 Lower Connecting Rod Attachment

15 Upper Connecting Rod Attachment

16 Top Mount Plate

17 Driver

18 Driver End Button

### DETAILED DESCRIPTION—FIGS. 1A, 1B—PREFERRED EMBODIMENT

A preferred embodiment of the apparatus of the present invention is illustrated in FIG. 1A (top view) and FIG. 1B (side view). The apparatus has a rigid driver (17) consisting of a rigid material that can move forward and back through a fixed housing (12) without fracturing. The fixed housing (11) is attached to a Top Mount Plate (16) by a rigid attachment means, such as a weld, rivet, screw or bolt, etc. . . .

The Top Mount Plate (16) is attached to the conventional power saw by a rigid means, such as a rivet, screw or bolt, etc. . . . In a preferred embodiment that Top Mount Plate (16) is attached to the conventional power saw through attachment means currently utilized by the saw manufacturer.

Along the driver housing (12) is a Clip (13) which secures the driver housing (12) along with the top mount plate (16) to the saw.

At one end of the driver (17), a button (18) is placed for enhanced control and comfort of the operator. The preferred embodiment of the button (18) is concave, but can also be flat.

On the opposite end of the driver (17), is attached a fixed connecting rod (11), attached by tipper connecting rod attachment (15). In the preferred embodiment, the connecting rod attachments (15) are rivets, but cain be any type of attachment parts that attach material together, such as screws or bolts.

In the preferred embodiment, the connecting rod (11) is a rigid metal steel, however can consist of any other rigid material that can be repeatedly engaged without bending or fracturing.

At the opposite end of the fixed connecting rod is a lower connecting rod attachment (14) which is connected to the Power Saw's movable lower safety guard.

In the preferred embodiment, the lower connecting rod attachment (14) is attached to the movable lower safety by an attachment mechanism, which can be in the form of a rivet, screw or bolt or other similar attachment mechanism.

There are various possibilities with regard to the manual safety guard apparatus for manually moving the lower movable safety guard. The apparatus has a rigid driver (17) consisting of rigid material that can move forward and back through a rigid housing (11) without bending or fracturing. The housing (11) is attached to a Top Mount Plate (16) by a rigid attachment means, such as a weld, rivet, screw or bolt, etc. . . .

The Top Mount Plate (16) is attached to the conventional power saw by a rigid attachment means, such as a rivet, screw or bolt, etc. . . . In a preferred embodiment that Top Mount Plate (16) is attached to the conventional power saw through attachment means on either side of the power saw handle currently utilized by the saw manufacturer. This embodiment permits the use of the apparatus for a left handed operator as easily as a right handed operator.

FIGS. 1A and 1B show the manner of using the manual safety guard apparatus for manually moving a movable lower safety guard on a conventional power saw which only requires the operator to depress the Driver End Button (18) forward, so that the Driver (17) passes through the Driver Housing (12), causing the rigid connecting rod (11) to shift to a position that extracts the movable lower safety guard out of the way of the operator's view.

The movable lower safety guard immediately moves back into its original position whenever the operator releases pressure or disengages from the driver end button (18). Therefore, should an operator need to place the lower movable saw guard in an open position, he will not need to use other hands or use other objects to “wedge” the guard open, as the operator is able to operate the saw and manually move the guard into an open position with one hand. The guard will always be replaced in its originally closed position once the operator releases the button.

I claim:

1. A lower safety saw guard lifting apparatus for manually lifting a lower safety saw guard of a conventional electrical power saw possessing, a circular saw blade, comprising:
a lifting means for lifting the lower safety guard of the power saw, the lifting means secured to said saw and mechanically connected to said lower safety guard; and
said lifting means mechanically connected to an activating button of said saw, wherein said lifting means lifts said lower safety guard when the activating, button is manually depressed, and wherein said lifting means closes said safety guard when said button is released;
wherein said lifting means comprises:
a rigid open sleeve secured to the fixed housing of said saw, said sleeve having a first end and a second end;
a rigid driver movingly placed inside said sleeve;
said driver having two opposite ends, both said driver ends extending beyond said ends of said sleeve;
one of said driver ends connected to an activating end button;
a rigid rod having opposite ends, one of said ends of said rigid rod secured to said end of said driver opposite said end button;
said opposite end of said rigid rod mechanically connected to lower guard
said rigid rod mechanically connected to said lower safety guard for moving the said lower safety guard between the open and closed positions.

2. A lower safety saw guard lifting apparatus for manually lifting a lower safety saw guard of a conventional electrical power saw possessing a circular saw blade, comprising:
a lifting means for lifting the lower safety guard of the power saw, the lifting means secured to said saw and mechanically connected to said lower safety guard; and
said lifting means mechanically connected to an activating button of said saw, wherein said lifting means lifts said lower safety guard when the activating button is manually depressed, and wherein said lifting means closes said safety guard when said button is released;
wherein said lifting means comprises:
a rigid open sleeve secured to the fixed housing of said saw, said sleeve having a first end and a second end;
a rigid driver movingly placed inside said sleeve;
said driver having two opposite ends, both said driver ends extending beyond said ends of said sleeve;
one of said driver ends connected to an activating end button;
a rigid rod having opposite ends, one of said ends of said, rigid rod secured to said end of said driver opposite said end button;
said rod movingly placed inside said saw housing, wherein said opposite end of said rod mechanically connected said lower safety guard opposite the lower safety guard's spring for moving the said lower safety guard between the open and closed positions.
